(19) United States
(12) Patent Application Publication
(10) Pub. No.: US 2016/0095328 A1
(43) Pub. Date: Apr. 7, 2016

(54) Transportable Barbecue Smoker Trailer

(71) Applicant: Ryan M. Reed, Chatsworth, GA (US)

(72) Inventor: Ryan M. Reed, Chatsworth, GA (US)

(21) Appl. No.: 14/505,253

(22) Filed: Oct. 2, 2014

(51) Int. Cl. A23B 4/052; A23B 4/044; B62D 63/08; B60D 1/00

(52) U.S. Cl. CPC A23B 4/0523; B60D 1/00; A23B 4/044; B62D 63/08; B60D 2001/001

(57) ABSTRACT

A barbecue smoker trailer having a separate heat source and improved air flow for providing even heating and smoke to the cooking chamber such that barbecuing, grilling and smoking temperatures can be reached within the cooking chamber and maintained without direct or open flames. The smoker trailer also has detachable parts that can easily be removed and placed inside the cooking chamber for storage or shipping.

### CROSS REFERENCE TO RELATED APPLICATIONS

None.

### STATEMENT REGARDING FEDERALLY SPONSORED RESEARCH OR DEVELOPMENT

None.

### TECHNICAL FIELD

This disclosure relates to barbecue grillers and smokers in general, and more specifically to transportable barbecue smokers having a reverse air flow system and an external heating source.

### BACKGROUND

The art of cooking over an open flame or grilling outdoors has been enjoyed by many for hundreds of years. Various improvements in the art, such as increases to the control of the heating temperature, and the ability to increase or decrease the amount of air circulation have been implemented.

One substitute for cooking over an open flame is to provide indirect heat through smoke such that temperatures sufficient to grill or barbecue meats and vegetables can be achieved without placing the food in direct contact with an open flame, thereby eliminating the risk of charring the food.

Smoking also allows for the infusion of a variety of flavors through the introduction of different types of wood or other combustibles.

Many prior art barbecue smokers suffer from various shortcomings, including uneven heat distribution within the cooking chamber, a lack of portability and transportability, as well as difficulty in providing suitable heat for grilling and barbecuing from a chamber that is separate from the cooking chamber.

### SUMMARY

In general, this disclosure provides a transportable barbecue smoker containing an evenly heated cooking chamber with a separate fire chamber for generating and supplying sufficient heat and smoke to enable barbecuing and grilling without direct flames and the associated risks of charred food.

In one exemplary embodiment, the main components of the smoker are the fire chamber where the fire is built, the cooking chamber where the food is cooked, the triangular distribution channel for transferring the heat and smoke from the fire chamber to the cooking chamber, and the smoke stacks where the heat and smoke exit the cooking chamber. The smoker also has a trailer assembly for attachment to a vehicle when transporting, that can also be detached and dis-assembled when shipping the smoker.

In another exemplary embodiment, the triangular distribution channel for transferring the heat and smoke from the fire chamber to the cooking chamber may have holes toward the end of the channel after it enters the cooking chamber to allow for increased flow of heat and smoke into the cooking chamber earlier.

### OBJECTS AND ADVANTAGES

It is an object to provide a barbecuing and smoking apparatus that can reach sufficient heating temperatures to grill and barbecue without charring caused by direct exposure to flames.

It is an object of the invention to provide a transportable barbecuing and smoking apparatus that can be easily moved from one location to another, yet be stable and well supported when in use.

It is a further object to provide a barbecuing and smoking system that can be easily assembled by consumers when shipped to them. The barbecue and smoking system has separable components that can be nested and compacted so as to minimize shipping dimensions and thereby reducing shipping costs for both the manufacturer and consumers.

It is also an object to provide a scalable barbecuing smoking apparatus that can be used for personal use at home, or sized for larger gatherings or even commercial applications.

It is another object to provide improved temperature control and airflow for the cooking chamber so that all the food in the cooking chamber is cooked evenly.

It is additionally an object to provide a triangular channel for conducting and transporting heat that also causes fat and grease to flow down the angled sides toward bottom of the cooking chamber.

It is a further object to provide a barbecue and smoking apparatus that requires less cleaning and maintenance of the cooking chamber.

It is also an object to provide an improved air flow system that channels the heat and smoke from the fire chamber through the triangular distribution channel, and into the cooking chamber at an increased rate.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF DRAWINGS

The present embodiments are illustrated by way of the figures of the accompanying drawings, which may not necessarily be to scale, in which like references indicate similar elements, and in which:

FIG. 1 shows a back perspective view of the barbecue smoker trailer.

FIG. 2 illustrates a front perspective view of the barbecue smoker trailer.

FIG. 3 shows a right side perspective view of the barbecue smoker trailer.

FIG. 4 shows a left side perspective view of the barbecue smoker trailer.

FIG. 5 shows a top perspective view of the barbecue smoker trailer.

FIG. 6 shows a side view of the triangular channel from inside the cooking chamber.

FIG. 7 shows a top perspective view of the interior of the cooking chamber.

FIG. 8 shows a top perspective view of the interior of the fire chamber.

FIG. 9 shows a side perspective view of the embodiment with channel holes at the top of the triangular channel.

### DETAILED DESCRIPTION OF DRAWINGS

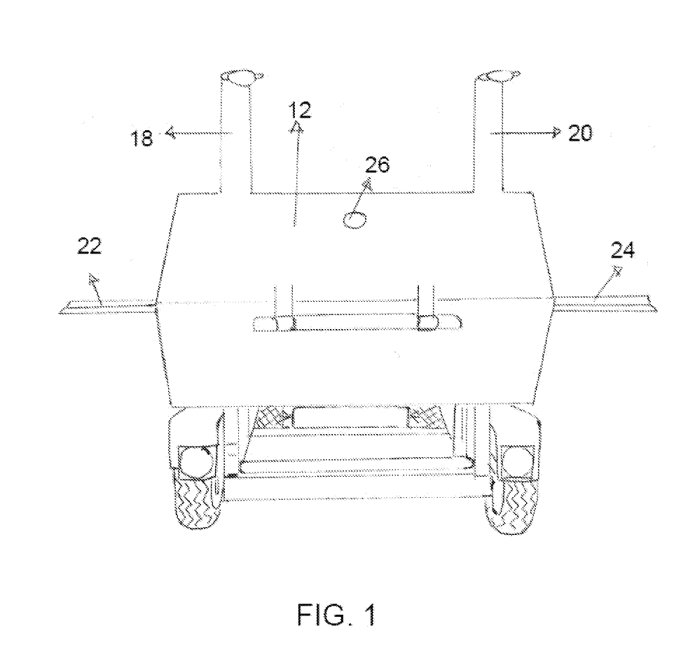

In FIG. 1, the cooking chamber 12 of the transportable barbecue smoker trailer 10 is shown from the view of the person grilling. The transportable barbecue trailer 10 has two tables, a left table 22, and a right table 24 for holding food, utensils and grilling products, a temperature gauge 26 in the center of the cooking chamber 12, and a left 18 and right smoke stack 20 for exhaust of the smoke from the cooking chamber.

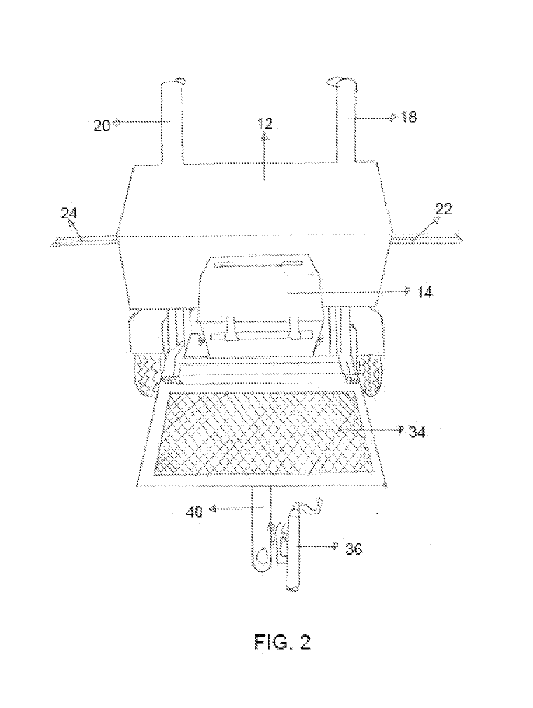

In FIG. 2, the front of the firebox chamber 14 is shown along with the rear of the cooking chamber 12. The user can add firewood from the firewood platform 34 to the firebox chamber 14 without the reduction of heat and smoke associated with opening the cooking chamber 12. The tongue 40 attaches the trailer jack 36 which is used for connecting to a vehicle for transporting the trailer.

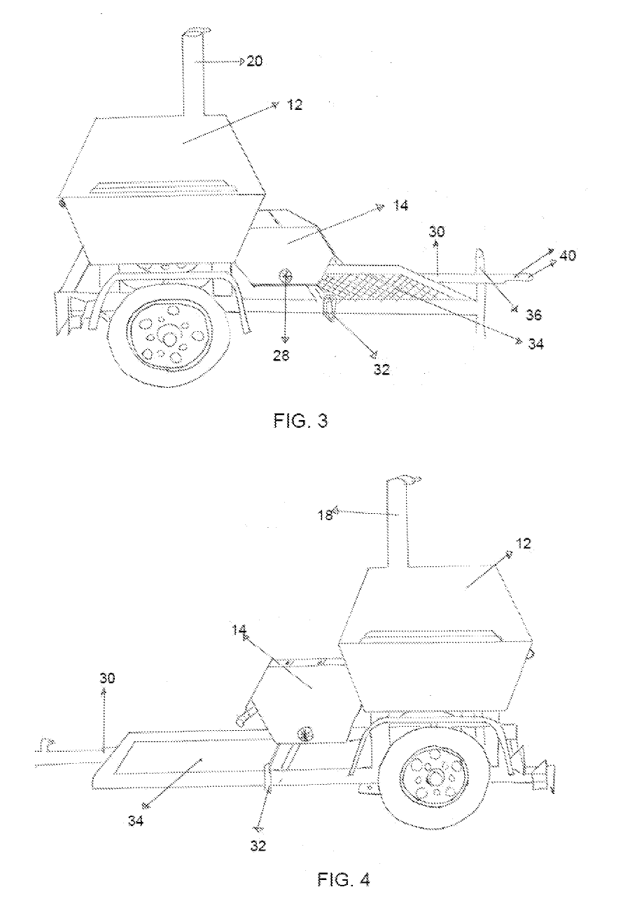

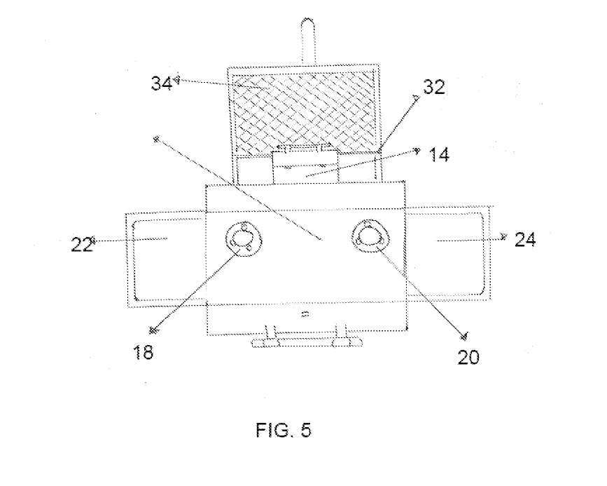

In FIG. 3, the right side of the firebox chamber 14 is seen along with the draft control knob 28 for regulating air flow into the firebox chamber 14. The trailer assembly connection point 32, and the tongue disconnection point 30 allow for the firewood platform 34 and the tongue 40 to be easily removed or disassembled for shipping.

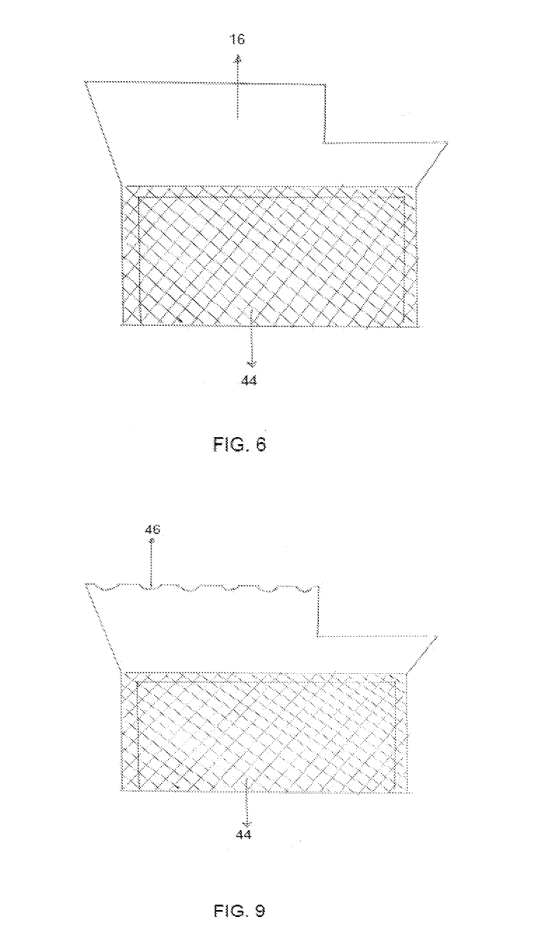

FIG. 6 shows a perspective view of the inside of the cooking chamber 12, where the sides of the triangular channel 16 meet the cooking grate 44. The triangular channel 16 allows heat to be released through the sides to assist in a more evenly heated cooking chamber.

FIG. 7 shows the inside of the cooking chamber 12, where the triangular channel 16 runs along the middle of the chamber and has a narrowing channel opening 42 for releasing the smoke into the front of the chamber. The cooking grate 44 holds the food being cooked and allows the drippings to drop down below the grate and away from the food.

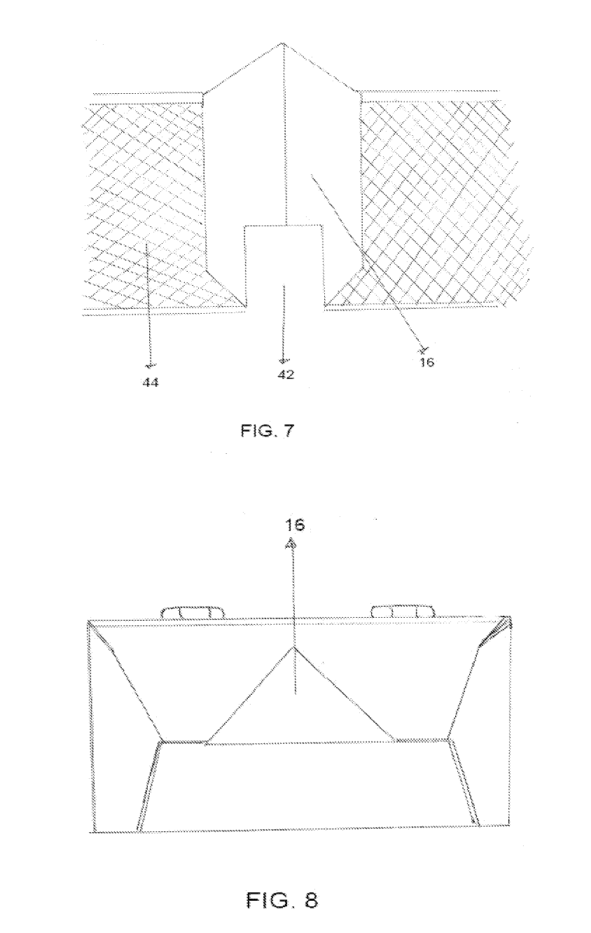

FIG. 8 shows the inside of the firebox chamber 14 where the triangular channel 16 originates to carry the heat and smoke from the wood or fuel burning inside the firebox chamber 14 through the triangular channel 16 and into the cooking chamber 12.

FIG. 9 shows a perspective view of the inside of the cooking chamber where the sides of the triangular channel meet the cooking grate 44. The channel holes 46 at the top of the channel allow for earlier and more rapid distribution of the heat and smoke into the cooking chamber.

### Detailed Description of Illustrative Embodiments

The following detailed description is illustrative of an exemplary embodiment of the transportable barbecue smoker trailer. The description is not to be taken as a limitation of the embodiments of the trailer, but as a representation of one of the many embodiments that fall within the scope of the appended claims.

The barbecue smoker trailer provides the temperature advantages of an open flame barbecue grill without the prior art disadvantages of charred meats and risk of grease-induced flare ups. The heat and smoke is created in the external firebox chamber and provided through the narrowing triangular channel to the cooking chamber. The channels triangular shape increases the flow of heat and smoke from the firebox chamber to the cooking chamber. The narrowing point at the top of the triangular channel going into the cooking chamber, compounded by heats natural propensity to rise causes an increase in the air flow speed through the channel and into the cooking chamber. The increased air flow rate through the channel draws more air into the firebox chamber, enabling a higher temperature for barbecuing and grilling.

As the heat and smoke flow through the triangular channel to the opening in the center of the back of the cooking chamber, and towards the channel opening at the center of the front of the cooking chamber, some of the heat is released through the channel walls into the cooking chamber. The remaining heat and all of the smoke are released into the cooking chamber when they reach the opening at the center of the front of the chamber.

In an alternate embodiment the heat and smoke flow through the triangular channel into the cooking chamber and begin releasing into the chamber through the channel holes that are inside the cooking chamber. The channel holes allow the heat and smoke to be released more quickly inside the cooking chamber providing higher cooking temperatures and greater smoking potential more quickly.

The heat and smoke are released from the cooking chamber through the smoke stacks that are located at opposite sides of the back of the cooking chamber. The improved flow of the smoke and heat from its entrance at the center of the front of the cooking chamber, throughout the cooking chamber, and finally to its exit from the smoke stacks at the rear sides of the top of the cooking chamber creates a reversal in the air flow to the side of its original entry point. The reverse flow causes a more even heat and smoke distribution and enables higher overall cooking temperatures within the cooking chamber.

The improved flow of heat and smoke throughout the cooking chamber ensures that the food in all areas of the chamber is evenly cooked and avoids the cold spots associated with prior art grills with direct heat from open flames, and the charring that can also occur with open flames.

Having the heat and smoke source separate from the cooking chamber allows the cooking chamber to be opened only for checking the food instead of having to also open the chamber to check on and adjust the wood and fire and thereby reduce the cooking temperature and dissipating the smoke needed to properly cook and flavor the food. The external firebox chamber in conjunction with the triangular channel for improved delivery of the heat and smoke into the cooking chamber provide the advantages of having a heat source internal to the cooking chamber without all of the disadvantages.

Additional advantages of the external firebox chamber are that the cooking chamber does not have to be opened to manage the chambers grilling and barbecuing temperatures, nor does the cooking chamber have to be cleaned as often without the wood, charcoal or other fuels normally required in an open flame grill.

The barbecue smoker trailer is scalable in size to accommodate a variety of quantities of food. As the size of the cooking chamber increases in size, the size of the firebox chamber increases proportionately.

Though comprised of several large components, the barbecue smoker trailer can be shipped in a single box due to its variety of disconnection points. The disconnection points illustrated in the drawing figures exemplify the ability to disconnect the different portions of the barbecue smoker trailer such that the removed portions can be placed inside the cooking chamber for a significant reduction in overall volume of the packaging for shipping, thereby greatly reducing shipping costs. The firewood platform, trailer jack, smoke stacks, tables and tongue can be disconnected and packaged inside the cooking chamber for shipping or transporting.

An illustrative embodiment of the barbecue smoker trailer has been described. Nevertheless, it will be understood that various modifications may be made without departing from the spirit and scope of the various embodiments presented herein. For example, the cooking chamber could have multiple levels of cooking grates to increase the surface area available for cooking and smoking food. Additionally, the cooking chamber and firebox chamber can be adapted to be free-standing and stationary when removed from the trailer. Accordingly, other embodiments are within the scope of the following claims.

What is claimed is:

1. A smoking and grilling apparatus with increased airflow and an indirect heating source comprising:
a cooking chamber having front, back, top and bottom sections,
a firebox chamber for providing the heat and smoke for said cooking chamber,
a triangular channel member for connecting the firebox and cooking chambers, and
one or more smoke stacks for releasing excess heat and smoke from the cooking chamber.

2. The apparatus of claim 1 wherein the triangular channel member contains a narrowing opening within the cooking chamber for releasing heat and smoke into the cooking chamber.

3. The apparatus of claim 1, wherein the triangular channel member contains a plurality of channel holes within the cooking chamber whereby heat and smoke can more rapidly be disbursed within the cooking chamber.

4. The apparatus of claim 1, further comprising a removable trailer and hitch whereby the apparatus can be transported from one location to another.

5. The apparatus of claim 2, wherein the flow of heat and smoke from the front of the cooking chamber to the smoke stacks at the back of the top of the cooking chamber creates an increased heat flow throughout the cooking chamber for barbecuing and grilling.

6. The apparatus of claim 1, further comprising a trailer for transporting said apparatus.

7. The apparatus of claim 5, further comprising a temperature gauge within the cooking chamber on the exterior door whereby the interior temperature can be determined without opening the cooking chamber.

8. The apparatus of claim 5, further comprising one or more tables for holding food items, grilling utensils or other smoking and grilling items.

9. The apparatus of claim 1, wherein the angled sides of the triangular channel reduce grease buildup on top of the channel.

10. The apparatus of claim 1, wherein the portion of the triangular channel that is inside the cooking chamber channel has a plurality of holes in the sides of the channel for earlier and increased heat and smoke passage into the cooking chamber.

11. The apparatus of claim 6, wherein the trailer parts and cooking chamber parts can be removed and placed inside the cooking chamber for shipping.

12. A method for providing even barbecuing and grilling temperatures throughout a cooking chamber whereby meat and vegetables can be grilled or smoked without exposure to direct flames comprising:
providing a cooking chamber having a front and back portion for holding food to be cooked,
providing a fire chamber for creating the heat and smoke for cooking,
providing a triangular channel for connection of the fire chamber and the cooking chamber and extending from the rear of the cooking chamber to the front of the chamber,
providing a narrowing opening in the triangular channel at the front of the cooking chamber, and
providing exhausting pipes at the back of the cooking chamber such that the heat and smoke entering the cooking chamber from the narrowing triangular opening is entering the cooking chamber at the front of the chamber and must flow through the chamber and rise up to the back of the cooking chamber to reach the exhaust pipes at the top of the rear of the cooking chamber.

13. A transportable smoking and grilling barbecue trailer comprising:
a cooking chamber for holding the food to be cooked,
an external heating means for providing heat to the cooking chamber, and
a trailer and hitch system for carrying and transporting the cooking chamber and external heating means.

14. The transportable smoking and grilling barbecue trailer of claim 12 wherein the external heating means comprises a firebox for wood and fuel combustion, and a triangular channel for connecting the firebox to the cooking chamber whereby passage of the heat and smoke from the firebox to the is cooking chamber is freely permitted.

15. The transportable smoking and grilling barbecue trailer of claim 12 further comprising one or more connection points for assembly and disassembly of the trailer for shipping and or transportation.
